(19) United States
(12) Patent Application Publication
(10) Pub. No.: US 2025/0365762 A1
(43) Pub. Date: Nov. 27, 2025

(54) COPING WITH CONSISTENT LISTEN-BEFORE-TALK FAILURE

(71) Applicant: Nokia Technologies Oy, Espoo (FI)

(72) Inventors: Nuno Manuel KIILERICH PRATAS, Aalborg (DK); Jakob Lindbjerg BUTHLER, Aalborg (DK); Laura Luque SANCHEZ, Aalborg (DK); Torsten WILDSCHEK, Gloucester (GB); Renato Barbosa ABREU, Aalborg (DK); Jianguo LIU, Shanghai (CN); Yong LIU, Shanghai (CN); Naizheng ZHENG, Beijing (CN); Thomas Haaning JACOBSEN, Aalborg (DK)

(21) Appl. No.: 19/287,566

(22) Filed: Jul. 31, 2025

Related U.S. Application Data
(63) Continuation of application No. PCT/CN2023/076294, filed on Feb. 15, 2023.

(51) Int. Cl. H04W 74/0808

(52) U.S. Cl. CPC H04W 74/0808

(57) ABSTRACT

Example embodiments of the present disclosure relate to coping with consistent listen-before-talk (LBT) failure. A first terminal device may determine that a consistent listen-before-talk, LBT, failure on a set of sidelink resources is detected; and transmit, to at least one of a second terminal device or a network device, information related to the consistent LBT failure. In this way, reliability of sidelink communication may be improved even in consistent LBT failure situations.

### CROSS-REFERENCE TO RELATED APPLICATION

This application is a bypass continuation of PCT Application No. PCT/CN2023/076294, filed on Feb. 15, 2023, which is hereby incorporated herein by reference in its entirety.

### FIELD

Example embodiments of the present disclosure generally relate to the field of telecommunication, and in particular, to apparatuses, methods and a computer-readable storage medium for coping with consistent listen-before-talk (LBT) failure.

### BACKGROUND

The New Radio (NR) operation in unlicensed bands relies on the user equipment (UE) sensing the radio resources before commencing transmission. This technique is known as LBT. In NR in unlicensed spectrum (NR-U), to co-exist with other wireless technology on unlicensed band e.g. Wi-Fi system, a LBT procedure may be performed before each transmission to occupy the channel.

The sidelink (SL) transmission may also operate on unlicensed bands. The LBT mechanism in NR-U may be introduced for the SL transmission to co-exist with other wireless systems on the unlicensed bands. Before each SL transmission, the SL UE may perform a LBT procedure and drop the SL transmission if LBT fails. Enhancements on SL in unlicensed spectrum (SL-U) are still needed.

### SUMMARY

In general, example embodiments of the present disclosure provide a solution for coping with consistent LBT failure.

In a first aspect, there is provided a first terminal device. The first terminal device comprises at least one processor and at least one memory storing instructions. When executed by the at least one processor, the instructions cause the first terminal device at least to: determine that a consistent listen-before-talk (LBT) failure on a set of sidelink resources is detected; and transmit, to at least one of a second terminal device or a network device, information related to the consistent LBT failure.

In a second aspect, there is provided a second terminal device. The second terminal device comprises at least one processor and at least one memory storing instructions. When executed by the at least one processor, the instructions cause the second terminal device at least to: receive information related to a consistent listen-before-talk (LBT) failure, which is detected by a first terminal device on a set of sidelink resources; and transmit, to the first terminal device, at least one sidelink transmission on at least one sidelink resource determined based on the received information.

In a third aspect, there is provided a network device. The network device comprises at least one processor and at least one memory storing instructions. When executed by the at least one processor, the instructions cause the network device at least to: receive, from a first terminal device, first information related to a consistent listen-before-talk (LBT) failure, which is detected by the first terminal device on a set of sidelink resources; and transmit, to a second terminal device, second information determined based on the first information.

In a fourth aspect, there is provided a method. The method comprises: determining, at a first terminal device, that a consistent listen-before-talk (LBT) failure on a set of sidelink resources is detected; and transmitting, to at least one of a second terminal device or a network device, information related to the consistent LBT failure.

In a fifth aspect, there is provided a method. The method comprises: receiving, at a first terminal device, information related to a consistent listen-before-talk (LBT) failure, which is detected by a first terminal device on a set of sidelink resources; and transmitting, to the first terminal device, at least one sidelink transmission on at least one sidelink resource determined based on the received information.

In a sixth aspect, there is provided a method. The method comprises: receiving, at a network device and from a first terminal device, first information related to a consistent listen-before-talk (LBT) failure, which is detected by the first terminal device on a set of sidelink resources; and transmitting, to a second terminal device, second information determined based on the first information.

In a seventh aspect, there is provided an apparatus. The apparatus comprises: means for determining that a consistent listen-before-talk (LBT) failure on a set of sidelink resources is detected; and means for transmitting, to at least one of a second terminal device or a network device, information related to the consistent LBT failure.

In an eighth aspect, there is provided an apparatus. The apparatus comprises: means for receiving information related to a consistent listen-before-talk (LBT) failure, which is detected by a first terminal device on a set of sidelink resources; and means for transmitting, to the first terminal device, at least one sidelink transmission on at least one sidelink resource determined based on the received information.

In a ninth aspect, there is provided an apparatus. The apparatus comprises: means for receiving, from a first terminal device, first information related to a consistent listen-before-talk, LBT, failure, which is detected by the first terminal device on a set of sidelink resources; and means for transmitting, to a second terminal device, second information determined based on the first information.

In a tenth aspect, there is provided an apparatus. The apparatus comprises: determining circuitry configured to determine that a consistent listen-before-talk (LBT) failure on a set of sidelink resources is detected; and transmitting circuitry configured to transmit, to at least one of a second terminal device or a network device, information related to the consistent LBT failure.

In an eleventh aspect, there is provided an apparatus. The apparatus comprises: receiving circuitry configured to receive information related to a consistent listen-before-talk (LBT) failure, which is detected by a first terminal device on a set of sidelink resources; and transmitting circuitry configured to transmit, to the first terminal device, at least one sidelink transmission on at least one sidelink resource determined based on the received information.

In a twelfth aspect, there is provided an apparatus. The apparatus comprises: receiving circuitry configured to receive, from a first terminal device, first information related to a consistent listen-before-talk (LBT) failure, which is detected by the first terminal device on a set of sidelink resources; and transmitting circuitry configured to transmit, to a second terminal device, second information determined based on the first information.

In a thirteenth aspect, there is provided a non-transitory computer-readable storage medium comprising program instructions. The program instructions, when executed by an apparatus, cause the apparatus to perform at least the method according to any one of the above fourth to sixth aspect.

In a fourteenth aspect, there is provided a computer program comprising instructions. The instructions, when executed by a first terminal device, cause the first terminal device at least to: determine that a consistent listen-before-talk (LBT) failure on a set of sidelink resources is detected; and transmit, to at least one of a second terminal device or a network device, information related to the consistent LBT failure.

In a fifteenth aspect, there is provided a computer program comprising instructions. The instructions, when executed by a second terminal device, cause the second terminal device at least to: receive information related to a consistent listen-before-talk (LBT) failure, which is detected by a first terminal device on a set of sidelink resources; and transmit, to the first terminal device, at least one sidelink transmission on at least one sidelink resource determined based on the received information.

In a sixteenth aspect, there is provided a computer program comprising instructions. The instructions, when executed by a network device, cause the network device at least to: receive, from a first terminal device, first information related to a consistent listen-before-talk (LBT) failure, which is detected by the first terminal device on a set of sidelink resources; and transmit, to a second terminal device, second information determined based on the first information.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, in which:

FIG. 1A illustrates an example of a network environment in which some example embodiments of the present disclosure may be implemented;

FIG. 1B illustrates an example of SL transmission procedure with Hybrid Automatic Repeat request (HARQ) feedback in which some example embodiments of the present disclosure may be implemented;

FIG. 1C illustrates an example of a SL slot in which some example embodiments of the present disclosure may be implemented;

FIG. 1D illustrates an example of channel mapping in SL transmissions in which some example embodiments of the present disclosure may be implemented;

FIG. 1E illustrates an example of an Inter-UE Coordination (IUC) information MAC CE for the first IUC scheme in which some example embodiments of the present disclosure may be implemented;

FIG. 1F illustrates an example of an IUC request MAC CE for the first IUC scheme in which some example embodiments of the present disclosure may be implemented;

FIG. 2 illustrates a flowchart illustrating a communication process in accordance with some example embodiments of the present disclosure;

FIG. 3 illustrate a flowchart illustrating a procedure in different cases for the behaviors of first terminal device in accordance with some example embodiment of the present disclosure;

FIG. 4 illustrates a flowchart of an example method implemented at a first terminal device in accordance with some example embodiments of the present disclosure;

FIG. 5 illustrates a flowchart of an example method implemented at a second terminal device in accordance with some example embodiments of the present disclosure;

FIG. 6 illustrates a flowchart of an example method implemented at a network device in accordance with some example embodiments of the present disclosure;

FIG. 7 illustrates a simplified block diagram of a device that is suitable for implementing some example embodiments of the present disclosure; and

FIG. 8 illustrates a block diagram of an example of a computer-readable medium in accordance with some example embodiments of the present disclosure.

Throughout the drawings, the same or similar reference numerals represent the same or similar elements.

### DETAILED DESCRIPTION

Principle of the present disclosure will now be described with reference to some example embodiments. It is to be understood that these embodiments are described for the purpose of illustration and help those skilled in the art to understand and implement the present disclosure, without suggesting any limitation as to the scope of the disclosure. The disclosure described herein may be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (for example, firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-loT) and so on. Furthermore, the communications between a terminal device and a network device in the communication network may be performed according to any suitable generation communication protocols, including, but not limited to, the fourth generation (4G), 4.5G, the fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, a low power node such as a femto, a pico, and so forth, depending on the applied terminology and technology. In the following description, the terms “network device” and “network node” may be used interchangeably.

The term “terminal device” refers to any end device that may be capable of wireless communication. Byway of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (for example, remote surgery), an industrial device and applications (for example, a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

As mentioned above, it is possible to introduce the LBT mechanism in NR-U to the sidelink transmission, so that the sidelink transmission may co-existed with other wireless systems on the unlicensed band. Before each sidelink transmission, the sidelink UE may perform a LBT procedure to occupy the channel and drop the sidelink transmission if LBT fails.

In RAN2 #119bis-e it was agreed that SL-U should support consistent LBT failure detection procedure. In a consistent LBT failure detection procedure, a device may count the number of LBT failures. If this counting goes beyond a threshold (provided by a device, NW or resource specific configuration), a consistent LBT failure is triggered. This counting occurs during a monitoring period or window, which can be started based on a device decision, triggered by the network or as a moving window. The duration of the monitoring window can be NW configuration, resource specific configuration or up to the device decision. The SL-specific consistent LBT failure detection (and recovery procedure) is a device centric occurrence and therefore has impact to any procedures where two or more devices interact. For example, if a transmitting (Tx) UE is not experiencing consistent LBT failure in a specific resource block (RB) set (or resource pool), the Tx UE is able to access the resources in the RB set (or resource pool), i.e. by successfully performing an LBT, and transmit its PSCCH/PSSCH transmission which the associated sidelink control information (SCI) requests for a HARQ feedback via a PSFCH resource mapped to the PSCCH/PSSCH resource. However, the Rx UE might be experiencing consistent LBT failure in the RB set in which the PSFCH is mapped to (or resource pool) and therefore is unable to access the mapped PSFCH resource to provide the HARQ feedback. In such event, the Tx UE will not know whether it should or should not perform an HARQ retransmission, so the communication cannot be assumed to be reliable.

There is a need to enhance the sidelink transmissions. Therefore, embodiments of the present disclosure provide a solution for coping with consistent LBT failure in sidelink communication.

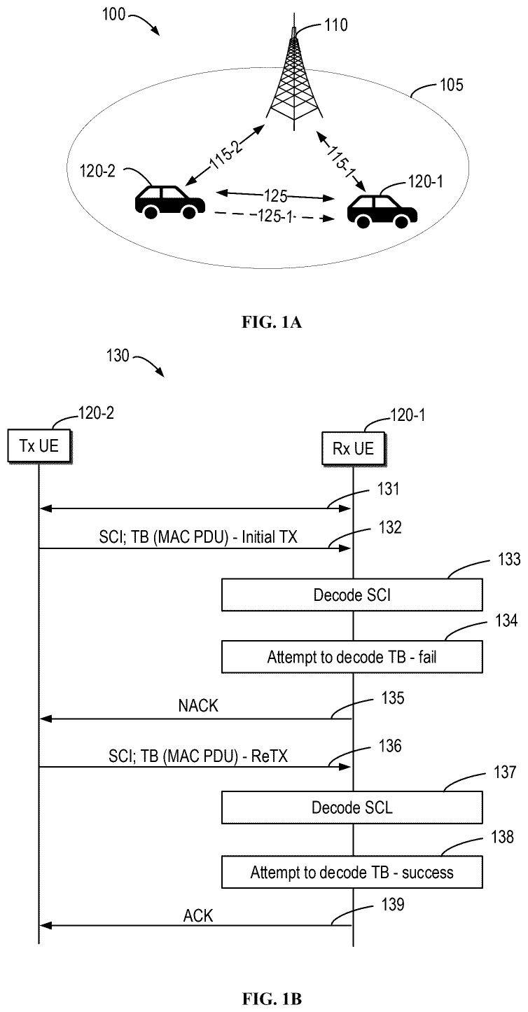

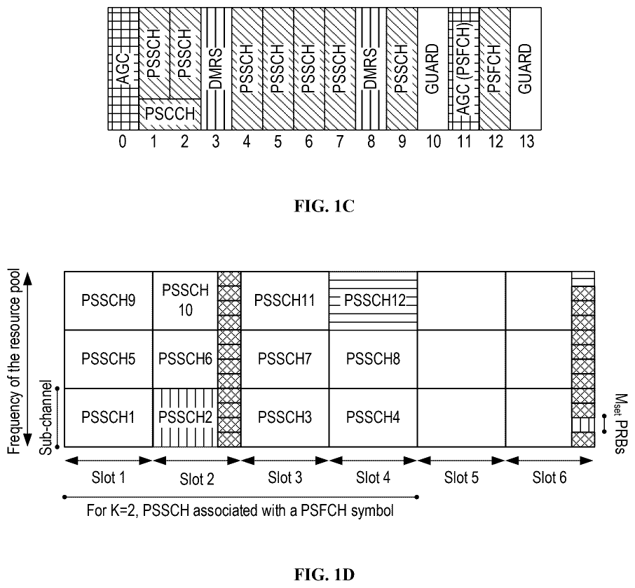

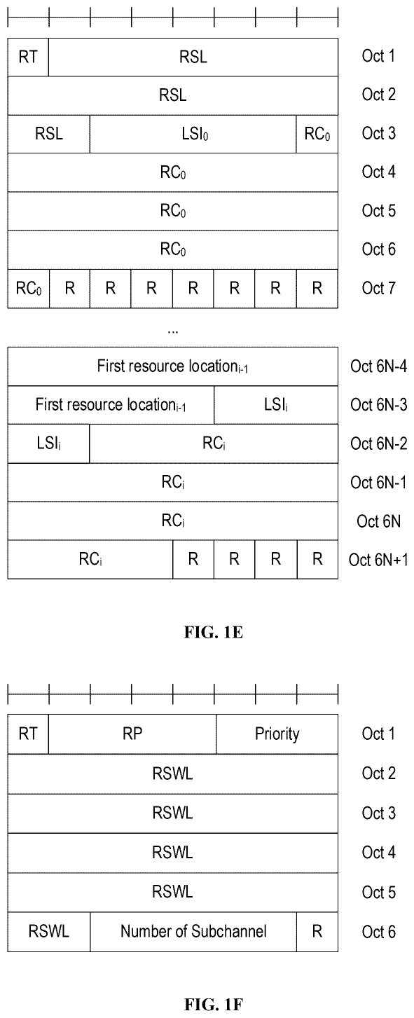

FIG. 1A illustrates an example of a network environment 100 in which some example embodiments of the present disclosure may be implemented. In the descriptions of the example embodiments of the present disclosure, the network environment 100 may also be referred to as a communication system 100 (for example, a portion of a communication network). For illustrative purposes only, various aspects of example embodiments will be described in the context of one or more terminal devices and network devices that communicate with one another. It should be appreciated, however, that the description herein may be applicable to other types of apparatus or other similar apparatuses that are referenced using other terminology.

As shown in FIG. 1A, the communication environment 100 includes a network device 110 (hereinafter may also be referred to as a gNB 110), a first terminal device 120-1 and a second terminal device 120-2. The network device 110 is associated with one or more serving areas, i.e. a land area called “cells”. As shown in FIG. 1A, the network device 110 manages a cell 105 and serves the first terminal device 120-1 and the second terminal device 120-2 (collectively referred to as terminal devices 120) in the cell 105. It is to be understood that the number of network devices, terminal devices and/or cells is provided for illustration purpose only without suggesting any limitation to the scope of the present disclosure. The communication system 100 may include any suitable number of network devices, terminal devices and/or cells adapted for implementing the present disclosure.

To transmit data and/or control information, the terminal devices 120-1 and 120-2 may perform communications with the network device 110, respectively. In particular, as illustrated in the exemplary scenario of FIG. 1A, the first terminal device 120-1 may communicate with the network device 110 via a communication link 115-1, and the second terminal device 120-2 may communicate with the network device 110 via a communication channel 115-2. For transmissions from the network device 110 to the terminal device 120-1 or 120-2, the communication link 115-1 or 115-2 may be referred to as a downlink, whereas for transmissions from the terminal device 120-1 or 120-2 to the network device 110, the communication link 115-1 or 115-2 may alternatively be referred to as an uplink.

In addition to the communication links 115-1 and 115-2, the first terminal device 120-1 and the second terminal device 120-2 may perform a sidelink transmission, which is also referred to as a device-to-device (D2D) communication, via a sidelink 125 between the first terminal device 120-1 and the second terminal device 120-2. For example, in the exemplary scenario of FIG. 1A, the second terminal device 120-2 (hereinafter may also be referred to as a Tx UE 120-2, a SL Tx UE 120-2 or an initiating terminal device 120-2) is to perform a sidelink transmission 125-1 to the first terminal device 120-1 (hereinafter may also be referred to as a Rx UE 120-1, a SL Rx UE 120-1 or a responding terminal device 120-1) via the sidelink 125. In some example embodiments, the sidelink transmission 125-1 may be performed in an unlicensed band in which various wireless devices based on different wireless technologies share the same wireless spectrum.

As used herein, the term “sidelink transmission” generally refers to any transmission performed from one terminal device to another terminal device. The sidelink transmission may be used for transmitting any data or control information associated with sidelink communications, for example, sidelink data, sidelink control information, sidelink feedback information, orthe like. As used herein, the term “sidelink channel” may generally refer to any channel used for sidelink communications, for example, Physical Sidelink Shared Channel (PSSCH), Physical Sidelink Control Channel (PSCCH), Physical Sidelink Discovery Channel (PSDCH), Physical Sidelink Broadcast Channel (PSBCH), Physical Sidelink Feedback Channel (PSFCH), and other existing or future sidelink channels.

Channel access in the sidelink may rely on the so-called LBT feature, in which before performing the sidelink transmission 125-1, the second terminal device 120-2 may first “sense” a communication channel to find out there are no communications on the communication channel prior to any transmission on the communication channel. For example, the “channel sensing” procedure may rely on detecting the energy level on the communication channel. The LBT parameters (such as type/duration, clear channel assessment parameters, and the like) may be configured in the second terminal device 120-2, for example, by the network device 110.

In some example embodiments, the network device 110 may be absent in the communication environment 100. For example, one or more of the terminal devices 120-1 and 120-2 as well as other terminal devices (not shown) may be outside of the coverage range (namely, outside of the cell 105) of the network device 110. In such cases, only sidelink communications may exist between one or more of the terminal devices 120-1, 120-2 and possibly other terminal devices not shown in FIG. 1A that may be outside the cell 105.

Although the network device 110 and the terminal devices 120-1, 120-2 are described in the communication environment 100 of FIG. 1A, embodiments of the present disclosure may equally apply to any other suitable communication devices in communication with one another. That is, embodiments of the present disclosure are not limited to the exemplary scenarios of FIG. 1A. In this regard, it is noted that although the network device 110 is schematically depicted as a base station and the terminal devices 120 are schematically depicted as vehicle-mounted terminal devices in FIG. 1A, it is understood that these depictions are exemplary in nature without suggesting any limitation. In other embodiments, the network device 110 and the terminal devices 120 may be any other communication devices, for example, any other wireless communication devices.

In case the terminal devices 120-1 and 120-2 are vehicle-mounted terminal devices, communication relate to them may be referred to as a V2X communication. More generally, although not shown in FIG. 1A, the V2X communication related to the terminal devices 120 may comprise a communication channel between the first or second terminal devices 120-1 or 120-2, respectively, and any other communication device, including but not limited to, an infrastructure device, another vehicle-mounted terminal device, a device of a pedestrian, a roadside unit, or the like. Furthermore, although not shown, all the communication links as shown in FIG. 1A may be via one or more relays.

Communications in the network environment 100 may be implemented according to any proper communication protocol(s), comprising, but not limited to, cellular communication protocols of the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

During 3GPP Rel-16, NR SL has been designed to facilitate an UE to communicate with other nearby UE(s) via direct/SL communication. Two resource allocation modes have been specified, and a SL Tx UE may be configured with one of them to perform its NR SL transmissions. These modes are denoted as NR SL mode 1 and NR SL mode 2. A sidelink transmission resource may be assigned or scheduled by the network device to the terminal device in NR SL mode 1, while the terminal device in NR SL mode 2 may autonomously select its SL transmission resources.

In sub-7 GHz unlicensed bands, the new radio (NR) coexistence with other systems, such as IEEE 802.11, is ensured via a Listen Before Talking (LBT) channel access mechanism. Similarly, a terminal device intending to perform a sideline (SL) transmission needs first to successfully complete an LBT check, before being able to initiate that same transmission.

For a terminal device, to pass an LBT check, it must observe the channel as available for a number of consecutive Clear Channel Assessment (CCA) slots. In sub-7 GHz the duration of these slots is 9 μs. The UE deems the channel as available in a CCA slot if the measured power, or the collected energy during the CCA slot, is below a regulatory specified threshold, which may depend on the operating band and geographical region.

In some example embodiments, when a Tx UE 120-2 initiates the sidelink communication, then the Tx UE 120-2 has to acquire the “right” to access the channel for a certain period of time, which is denoted in the regulations as Channel Occupancy Time (COT), by applying an “extended” LBT procedure where the channel must be deemed as free for the entire duration of a Contention Window (CW). This “extended” LBT procedure is named as LBT Type 1. The duration of both the COT and CW depends on the Channel Access Priority Class (CAPC) associated with the Rx UE 120-1's traffic. In some example embodiments, the Tx UE 120-2, which initiates the transmission upon successfully completing the LBT Type 1 and performs a SL transmission to the Rx UE 120-1 in PSCCH and PSSCH, acquires the COT1 with duration associated with the corresponding CAPC. The acquired COT1 is valid even in the case where the Tx UE 120-2 pauses its transmission, although if the Tx UE 120-2 wants to perform a new transmission (within the COT). It is still required to perform a “reduced” LBT procedure. This “reduced” LBT procedure may be named as LBT Type 2, as in 3GPP specification TS 37.213, with the following variants:

Type 2A (25 μs LBT) is for SL transmissions within the initiating device acquired COT, in case the gap between two SL transmissions is ≥25 μs, as well for SL transmissions following another SL transmission.

Type 2B (16 μs LBT) is for SL transmission within the initiating device acquired COT, which may only be used for SL transmissions following another SL with gap exactly equal to 16 μs.

Type 2C (no LBT) may only be used for SL transmission following another SL, with a gap <16 μs and the allowed duration of the SL transmission of ≥584 μs).

FIG. 1B illustrates an example of SL transmission procedure 130 with HARQ feedback in which some example embodiments of the present disclosure may be implemented. For the purpose of discussion, the SL transmission procedure 130 will be described with reference to FIG. 1A. The SL transmission procedure 130 may involve the Tx UE 120-2 and the Rx UE 120-1 as illustrated in FIG. 1A. It would be appreciated that although the communication process 130 has been described referring to the network environment 100 of FIG. 1A, this communication process 130 may be likewise applied to other similar communication scenarios.

As shown in FIG. 1B, at 131, a unicast establishment may be performed between the Tx UE 120-2 and the Rx UE 120-1. At 132, the Tx UE 120-2 may transmit an initial transmission to the Rx UE 120-1. The initial transmission may include SCI and TB comprising one or more MAC Protocol Data Units (PDUs). The SCI may follow a 2-stage SCI structure and indicates source ID, destination ID, cast type (=unicast), HARQ feedback enabled/disabled indicator and HARQ parameters, such as HARQ process number, new data indicator (NDI) and redundancy version (RV). For example, the SCI may indicate to enable HARQ feedback with the HARQ feedback enabled/disabled indicator. At 133, the Rx UE 120-1 may decode the SCI. At 134, the Rx UE 120-1 may attempt to decode the TB. At 135, if the decoding of the TB fails, the Rx UE 120-1 may transmit an indication of an unsuccessful data transmission to the Tx UE 120-2. For example, the indication may be represented as “NACK”. At 136, the Tx UE 120-2 may retransmit the SCI and the TB. At 137, the Rx UE 120-1 may decode the retransmitted SCI. At 134, the Rx UE 120-1 may attempt to decode the retransmitted TB. At 138, the Rx UE 120-1 may transmit an indication of a successful data transmission to the Tx UE 120-2 if the decoding of the TB successes. For example, the indication may be represented as “ACK”.

The PSFCH was introduced during Rel-16 to enable HARQ feedback over the sidelink from the Rx UE 120-1 that is the intended recipient of a PSSCH transmission, to the Tx UE 120-2 that performed the transmission. Within a PSFCH, a Zadoff-Chu sequence in one Physical Resource Block (PRB) is repeated over two OFDM symbols, the first of which may be used for AGC, near the end of the SL resource in a slot. FIG. 1C illustrates an example of a SL slot in which some example embodiments of the present disclosure may be implemented. The Zadoff-Chu sequence as base sequence may be pre-configured per sidelink resource pool.

The time resources for PSFCH are pre-configured to occur once every 0, 1, 2, or 4 slots according to 3GPP TS 38.331. The HARQ feedback resource in PSFCH is derived from the resource location of PSCCH/PSSCH. For PSSCH-to-HARQ timing, there is a configuration parameter K with the unit of slot. The time occasion for PSFCH is determined from K. For a PSSCH transmission with its last symbol in slot n, HARQ feedback is in slot n+a where a is the smallest integer larger than or equal to K with the condition that slot n+a contains PSFCH resources. The time gap of at least K slots allows considering the Rx UE 120-1's processing delay in decoding the PSCCH and generating the HARQ feedback. K may be equal to 2 or 3, and a single value of K may be pre-configured per resource pool. This allows several Rx UEs using the same resource pool to utilize the same mapping of PSFCH resource for the HARQ feedback. With the parameter K, the N PSSCH slots associated with a slot with PSFCH may be determined.

FIG. 1D illustrates an example of channel mapping in which some example embodiments of the present disclosure may be implemented. The period of PSFCH resources is configured as N=4, where there are 4 PSSCH slots associated with the PSFCH, and K, or sl-MinTimeGapPSFCH is configured as 2. With L sub-channels in a resource pool and N PSSCH slots associated with a slot containing PSFCH, there are N*L sub-channels associated with a PSFCH symbol. With M PRBs available for PSFCH in a PSFCH symbol, there are M PRBs available for the HARQ feedback of transmissions over N*L sub-channels.

With M configured to be a multiple of N*L, then a distinct set of Mset=M/(N*L) PRBs may be associated with the HARQ feedback for each sub-channel within a PSFCH period. The first set of Mset PRBs among the M PRBs available for PSFCH are associated with the HARQ feedback of a transmission in the first sub-channel in the first slot. The second set of Mset PRBs are associated with the HARQ feedback of a transmission in the first sub-channel in the second slot and so on.

In some example embodiments, it is illustrated in FIG. 1D with N=4, L=3 and with all PRBs in a PSFCH symbol available for PSFCH. In this example, the HARQ feedback for a transmission at PSSCH x is sent on the set x of Mset PRBs in the corresponding PSFCH symbol, with x=1, . . . , 12.

In some example embodiments, the set of Mset PRBs associated with a sub-channel may be shared among multiple Rx UEs in case of ACK/NACK feedback for groupcast communications or in the case of different PSSCH transmissions in the same sub-channel. For each PRB available for PSFCH, there are Q cyclic shift pairs available to support the ACK or NACK feedback of Q Rx UEs within the PRB. For a resource pool, the number of cyclic shift pairs Q is pre-configured and may be equal to 1, 2, 3 or 6.

In some example embodiments, it may be computed the number F of PSFCH resources available for supporting the HARQ feedback of a given transmission. In 3GPP TS 38.213, F is denoted as

$${R}_{P RB , CS}^{P S F C H} .$$

With each PSFCH resource used by one Rx UE, F available PSFCH resources may beused for the ACK/NACK feedback of up to F Rx UEs.

In some example embodiments, the F PSFCH resources available for multiplexing the HARQ feedback for the PSSCH may be determined based on two options:

Option 1: F is based on the L PSSCH sub-channels used by a PSSCH, where the F may be computed as: F=L PSSCH*Mₛₑₜ*Q PSFCHs, which is associated with the L PSSCH sub-channels of a PSSCH. There are L PSSCH sub-channels of a PSSCH, Mₛₑₜ PRBs for PSFCH associated with each sub-channel, and Q cyclic shift pairs available in each PRB.

Option 2: F is based only on the starting sub-channel used by a PSSCH, or based only on one sub-channel for the case when L PSSCH>1). F=Mₛₑₜ*Q PSFCHs, which is associated with the starting sub-channel of a PSSCH. There are Mset PRBs for PSFCH associated with each sub-channel; and Q cyclic shift pairs available in each PRB.

In some example embodiments, the available F PSFCH resources may be indexed based on a PRB index in frequency domain, and a cyclic shift pair index in code domain. The mapping of the PSFCH index i (i=1, 2, . . . , F) to the PRBs and to the Q cyclic shift pairs is such that the PSFCH index i first increases with the PRB index until reaching the number of available PRBs for PSFCH. Then, it increases with the cyclic shift pair index, again with the PRB index and so on.

Among the F PSFCHs available for the HARQ feedback of a given transmission, the Rx UE selects for its HARQ feedback PSFCH with index i given by:

$$i = ( {T}_{ID} + {R}_{ID} ) mod F ,$$

where T_{ID} is the Layer 1 identity of the Rx UE, which is indicated in the 2nd-stage SCI. R_{ID}=0 for unicast ACK/NACK feedback and groupcast NACK-only feedback. The groupcast NACK-only feedback is groupcast option 1.

For groupcast ACK/NACK feedback, or groupcast option 2, R_{ID} is equal to the Rx UE identifier within the group, which is indicated by higher layers. For a number X of Rx UEs within a group, the Rx UE identifier is an integer between 0 and X−1. A Rx UE determines which PRB and cyclic shift pair should be used for sending its HARQ feedback based on the PSFCH index i. The Rx UE uses the first or second cyclic shift from the cyclic shift pair associated with the selected PSFCH index i in order to send NACK or ACK, respectively.

By Rx UEs selecting PSFCHs with index i, a Tx UE may distinguish the HARQ feedback of different Rx UEs via the Rx UE identifier, such as for groupcast option 2, and the HARQ feedback intended for the Tx UE via the Layer 1 ID of the Tx UE, such as for unicast. As R_{ID}=0 for groupcast option 1, the Rx UEs select the same PSFCH index i for their NACK-only feedback based solely on the Layer 1 ID Tx UE identifier T_{ID}.

In some example embodiments, the SL UEs may support inter-UE coordination (IUC) in mode 2, whereby a UE-A sends coordination information about resources to a UE-B and the UE-B then uses the coordination information for resource (re)selection. Two schemes of inter-UE coordination are supported. In a first IUC scheme, the coordination information sent from a UE-A to a UE-B is the preferred or non-preferred resources for UE-B's transmission. In a second IUC scheme, the coordination information sent from a UE-A to a UE-B is the presence of expected/potential resource conflict on the resources indicated by UE-B's SCI.

In the first IUC scheme, IUC can be triggered by an explicit request from UE-B, or by a condition at UE-A. UE-A determines the set of resources reserved by other UEs or slots where UE-A, when it is the intended receiver of UE-B, does not expect to perform SL reception from UE-B due to half-duplex operation. UE-A uses these resources as the set of non-preferred resources, or excludes these resources to determine a set of preferred resources and sends the preferred/non-preferred resources to UE-B. UE-B's resources for resource (re)selection can be based on both UE-B's sensing results (if available) and the coordination information received from UE-A, or it can be based only on coordination information received from UE-A. For the first IUC scheme, MAC CE and second-stage SCI or MAC CE only can be used to send IUC. The explicit request and reporting for IUC in unicast manner is supported. From TS 38.331, it is specified that by configuration, the triggering condition for sending a IUC Scheme 1 preferred/non-preferred resource message or an IUC scheme 1 request message is either by UE-A implementation or when UE-A has data to transmit.

In the second IUC scheme, UE-A determines the expected/potential resource conflict within the resources indicated by UE-B's SCI as either resources reserved by other UEs and identified by UE-A as fully/partially overlapping with the resources indicated by UE-B's SCI, or as slots where UE-A is the intended receiver of UE-B and does not expect to perform SL reception on those slots due to half-duplex operation. UE-B uses the conflicting resources to determine the resources to be reselected and exclude the conflicting resources from the reselected resources. For second IUC scheme, PSFCH is used to send IUC.

FIG. 1E illustrates an example of an IUC information MAC CE for the first IUC scheme in which some example embodiments of the present disclosure may be implemented. The IUC information MAC CE is identified by a MAC subheader with LCID as specified in Table 6.2.4-1. The priority of the IUC information MAC CE is fixed to ‘1’. It has a variable size with following fields: RT (resource set type, i.e., preferred resource set or non-preferred resource set); RSL (location of reference slot); LSI (lowest subchannel indices for the first resource location of each TRIV); RC (resource combination); First resource locationi-1 (first resource location) and R (Reserved bit).

FIG. 1F illustrates an example of an IUC request MAC CE for the first IUC scheme in which some example embodiments of the present disclosure may be implemented. The IUC request MAC CE is identified by a MAC subheader with LCID as specified in Table 6.2.4-1. The priority of the IUC request MAC CE is fixed to ‘1’. It has a variable size with following fields: RT (resource set type, i.e., preferred resource set or non-preferred resource set); RP (resource reservation period); Priority (priority); RSWL (resource selection window location); Number of Subchannel (number of subchannels); R (Reserved bit).

As mentioned above, in RAN2 #119bis-e it was agreed that SL-U should support consistent LBT failure detection procedure. The SL-specific consistent LBT failure detection (and recovery procedure) is a device centric occurrence and therefore has impact to any procedures where two or more devices interact. For example, the SL-specific consistent LBT failure might have impact on the HARQ feedback procedure, which may be illustrated in the following use cases.

In a use case (a), the Tx UE is experiencing a consistent LBT failure in specific RB sets (or resource pools) and therefore is prevented from accessing those specific RB set (or resource pools). In a sub-use case (a.i), the Rx UE is experiencing consistent LBT failure in the same RB sets (or resource pools) as the Tx UE. In a sub-use case (a.ii), the Rx UE is not experiencing consistent LBT failure in the same RB set (or resource pools) as the Tx UE.

In a use case (b), the Tx UE is not experiencing consistent LBT failure in a specific RB set (or resource pool) and therefore it is able to access the resources in the RB set (or resource pool), e.g. by successfully performing an LBT (either Type 1 or 2, depending on if a COT is available), and transmit its PSCCH/PSSCH transmission which the associated SCI requests for a HARQ feedback via a PSFCH resource mapped to the PSCCH/PSSCH resource. In a sub-use case (b.i), the Rx UE is not experiencing consistent LBT failure in the RB set in which the PSFCH is mapped to (or resource pool) and therefore the Rx UE is able to provide HARQ feedback using the mapped PSFCH resource. In a sub-use case (b.ii), the Rx UE is experiencing consistent LBT failure in the RB set in which the PSFCH is mapped to (or resource pool) and therefore is unable to access the mapped PSFCH resource to provide the HARQ feedback.

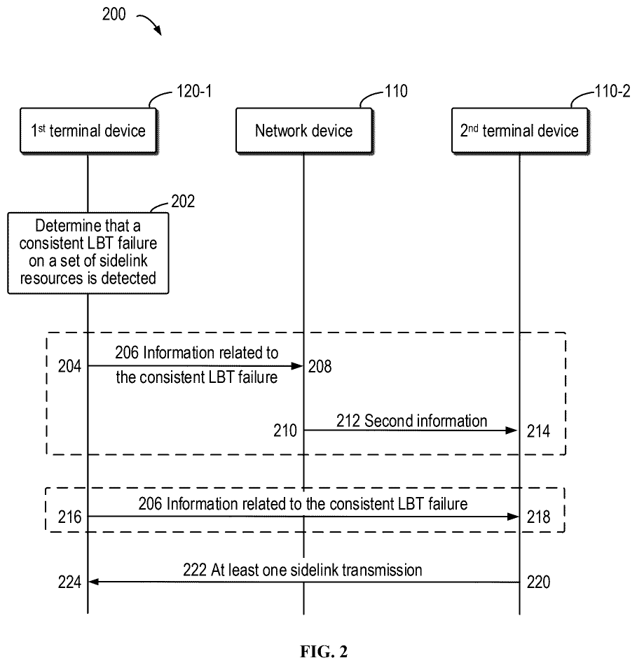

From these use cases, it can be seen that whenever the use case (b.ii) occurs, the Tx UE will not know if it should or not perform an HARQ retransmission, so the communication cannot be assumed to be reliable. In this disclosure, a solution is provided to cope with consistent LBT failure situations. This will be described in connection with FIGS. 2-8.

FIG. 2 illustrates a flowchart illustrating a communication process 200 in accordance with some example embodiments of the present disclosure. For the purpose of discussion, the communication process 200 will be described with reference to FIG. 1A. It would be appreciated that although the communication process 200 has been described referring to the network environment 100 of FIG. 1A, this communication process 200 may be likewise applied to other similar communication scenarios.

In the communication process 200, the first terminal device 120-1 determines (202) that a consistent (LBT) failure on a set of sidelink resources is detected. The first terminal device 120-1 transmits information 206 related to the consistent LBT failure to at least one of the second terminal device 120-2 or the network device 110.

In some example embodiments, the first terminal device 120-1 transmits (204) the information 206 related to the consistent LBT failure to the network device 110. The network device receives (208) the information 206 from the first terminal device 120-1 and transmits (210) second information 212 determined based on the information 206 to the second terminal device 120-2. The second terminal device 120-2 receives (214) the second information 212 from the network device 110. The second terminal device 120-2 transmits (220) at least one sidelink transmission 222 on at least one sidelink resource determined based on the received second information 212.

Alternatively or additionally, the first terminal device 120-1 transmits (216) the information 206 related to the consistent LBT failure to the second terminal device 120-2. The second terminal device 120-2 receives (218) the information 206 from the first terminal device 120-1. The second terminal device 120-2 transmits (220) at least one sidelink transmission 222 on at least one sidelink resource determined based on the received information 206.

In some example embodiments, the information 206 may comprise an indication that the consistent LBT failure is detected on the set of sidelink resources. In other words, the second terminal device 120-2 or the network device 110 receiving the information 206 may be aware that the occurrence of the consistent LBT failure on the first terminal device 120-1. Alternatively or additionally, the information 206 may comprise an indication of a duration of the consistent LBT failure. In other words, the second terminal device 120-2 or the network device 110 receiving the information 206 may be aware about how long will the consistent LBT failure lasts on the first terminal device 120-1. Alternatively or additionally, the information 206 may comprise an indication of the set of sidelink resources. In other words, the second terminal device 120-2 or the network device 110 receiving the information 206 may be aware about on which sidelink resources the consistent LBT failure occurs.

In some example embodiments, the set of sidelink resources may comprise at least one resource block (RB) set. Alternatively or additionally, the set of sidelink resources may comprise at least one resource pool. Alternatively or additionally, the set of sidelink resources may comprise at least one bandwidth part (BWP).

In some example embodiments, the first terminal device 120-1 may transmit the information 206 to the network device 110 based on determining that the first terminal device 120-1 is in coverage of the network device 110. In some example embodiments, the network device 110 may transmit the second information 212 to the second terminal device 120-2 based on determining that the second terminal device 120-2 is in coverage of the network device 110.

In some example embodiments, the second information 212 may comprise an indication that the consistent LBT failure is detected on the set of sidelink resources. Alternatively or additionally, the second information 212 may comprise an indication of a duration of the consistent LBT failure. Alternatively or additionally, the second information 212 may comprise an indication of the set of sidelink resources. In other words, the network device 110 may forward the content of the information 206 to the second terminal device 120-2. In some example embodiments, the network device 110 may transmit the second information 212 to the second terminal device 120-2 based on determining that the second terminal device 120-2 is in a second resource allocation mode. In this way, the second terminal device 120-2 may be aware of information related to the consistent LBT failure occurring on the first terminal device 120-1 and thus may be able to determine the at least one sidelink resource for the at least one sidelink transmission 222.

In some example embodiments, the second information 212 may comprise an indication of at least one sidelink resource allocated for at least one sidelink transmission 222 to be transmitted from the second terminal device 120-2 to the first terminal device 120-1. In some example embodiments, prior to receiving the second information 212 from the network device 110, based on determining that the second terminal device 120-2 is in a first resource allocation mode, the second terminal device 120-2 may transmit, to the network device 110, a request for allocating resources of the at least one sidelink transmission 222. Based on receiving the request, the network device 110 may determine the at least one sidelink resource allocated for the at least one sidelink transmission 222.

In some example embodiments, the first terminal device 120-1 may transmit the information 206 to the second terminal device 120-2 based on determining that the first terminal device 120-1 is out of coverage of the network device 110. In other words, the first terminal device 120-1 may transmit the information 206 to the second terminal device 120-2 when the first terminal device 120-1 is non-network-controlled. In some example embodiments, the first terminal device 120-1 may transmit the information 206 to the second terminal device 120-2 when the first terminal device 120-1 is in coverage of the network device 110. In other words, the first terminal device 120-1 may always transmit the information 206 to the second terminal device 120-2 regardless of whether the first terminal device 120-1 is network-controlled or not. In this way, the second terminal device 120-2 may be aware of information related to the consistent LBT failure occurring on the first terminal device 120-1 and thus may be able to determine the at least one sidelink resource for the at least one sidelink transmission 222.

In some example embodiments, when transmitting the information 206 to the second terminal device 120-2, the first terminal device 120-1 may transmit an IUC message comprising the information based on determining that there is an IUC between the first terminal device 120-1 and the second terminal device 120-2. In some example embodiments, the IUC message may comprise an indication of non-preferred resources including the set of sidelink resources. Alternatively or additionally, the IUC message may comprise an indication of preferred resources excluding the set of sidelink resources.

In some example embodiments, when transmitting the information 206 to the second terminal device 120-2, the first terminal device 120-1 may transmit PC5 radio resource control (PC5-RRC) UE assistance information (UAI) comprising the information based on determining that there is not an IUC between the first terminal device 120-1 and the second terminal device 120-2. Alternatively or additionally, the first terminal device 120-1 may transmit a medium access control (MAC) control element (CE) comprising the information based on determining that there is not an IUC between the first terminal device 120-1 and the second terminal device 120-2. For example, based on determining that a unicast link is established between the first terminal device 120-1 and the second terminal device 120-2, the first terminal device 120-1 may transmit the PC5-RRC comprising the information. Alternatively or additionally, based on determining that a unicast link is established between the first terminal device 120-1 and the second terminal device 120-2, the first terminal device 120-1 may transmit the MAC CE comprising the information. Alternatively or additionally, based on determining that a groupcast link is established between the first terminal device 120-1 and the second terminal device 120-2, the first terminal device 120-1 may transmit the MAC CE comprising the information.

In some example embodiments, the set of sidelink resources may be a first resource pool. The information 206 may be transmitted to the second terminal device 120-2 in a second resource pool different from the first resource pool, and the information 206 may comprise an indication of the first resource pool.

In some example embodiments, the at least one sidelink resource determined by the second terminal device 120-2 or allocated by the network device 110 may be mapped to at least one PSFCH resource different from the set of sidelink resources. In some example embodiments, when the at least one sidelink resource is allocated by the network device 110, the second information 212 may comprise an indication of enabling a HARQ feedback from the first terminal device 120-1 to the second terminal device 120-2 for the at least one sidelink transmission 222. In some example embodiments, the second terminal device 120-2 may transmit, to the first terminal device 120-1, an indication of enabling a HARQ feedback for the at least one sidelink transmission 222. In some example embodiments, the first terminal device 120-1 may receive (224) the at least one sidelink transmission 222 from the second terminal device 120-2 on the at least one sidelink resource and transmit a HARQ feedback to the second terminal device 120-2 for the at least one sidelink transmission.

In some example embodiments, the at least one sidelink resource determined by the second terminal device 120-2 or allocated by the network device 110 may be mapped to at least one PSFCH resource in the set of sidelink resources. In some example embodiments, when the at least one sidelink resource is allocated by the network device 110, the second information 212 may comprise an indication of disabling a HARQ feedback from the first terminal device 120-1 to the second terminal device 120-2 for the at least one sidelink transmission 222. In some example embodiments, the second terminal device 120-2 may transmit, to the first terminal device 120-1, an indication of disabling a HARQ feedback for the at least one sidelink transmission 222. In some example embodiments, the first terminal device 120-1 may receive (224) the at least one sidelink transmission 222 from the second terminal device 120-2 on the at least one sidelink resource and skip transmitting a HARQ feedback to the second terminal device 120-2 for the at least one sidelink transmission.

In some example embodiments, when transmitting the at least one sidelink transmission 222 on the at least one sidelink resource mapped to at least one PSFCH resource in the set of sidelink resources, the second terminal device 120-2 may reduce a modulation and coding scheme (MCS) of the at least one sidelink transmission 222. Alternatively or additionally, the second terminal device 120-2 may enable repetitions of the at least one sidelink transmission 222. In some example embodiments, the second information 212 may comprise an indication of a reduced MCS of the at least one sidelink transmission 222. Alternatively or additionally, the second information 212 may comprise an indication of repetitions of the at least one sidelink transmission.

Through the process flow 200, the second terminal device 120-2 may be aware of information related to the consistent LBT failure on the first terminal device 120-1. The second terminal device 120-2 may thus be able to cope with the consistent LBT failure when transmitting sidelink transmissions to the first terminal device 120-1.

For example, the second terminal device 120-2 may transmit the sidelink transmissions to the first terminal device 120-1 on resources mapped to at least one PSFCH resource where the first terminal device 120-1 is not experiencing consistent LBT failure. In such event, the second terminal device 120-2 may be able to provide HARQ feedback using the mapped PSFCH resource and the first terminal device 120-1 will know if it should or not perform an HARQ retransmission.

Alternatively, the second terminal device 120-2 may transmit the sidelink transmissions to the first terminal device 120-1 on resources mapped to at least one PSFCH resource where the first terminal device 120-1 is not experiencing consistent LBT failure. In such event, the second terminal device 120-2 would not require the first terminal device 120-1 to provide HARQ feedback and the second terminal device 120-2 may increase the robustness of the transmission, e.g., by reducing the MCS or enabling repetitions for the sidelink transmission, so as to increase the probability of reception.

In other words, the second terminal device 120-2 may be able to cope with lack of HARQ feedback, by taking into account if the first terminal device 120-1 is experiencing consistent LBT failure or not in the targeted RB sets (or resource pool). In this way, the reliability of sidelink communication may be improved even in consistent LBT failure situations.

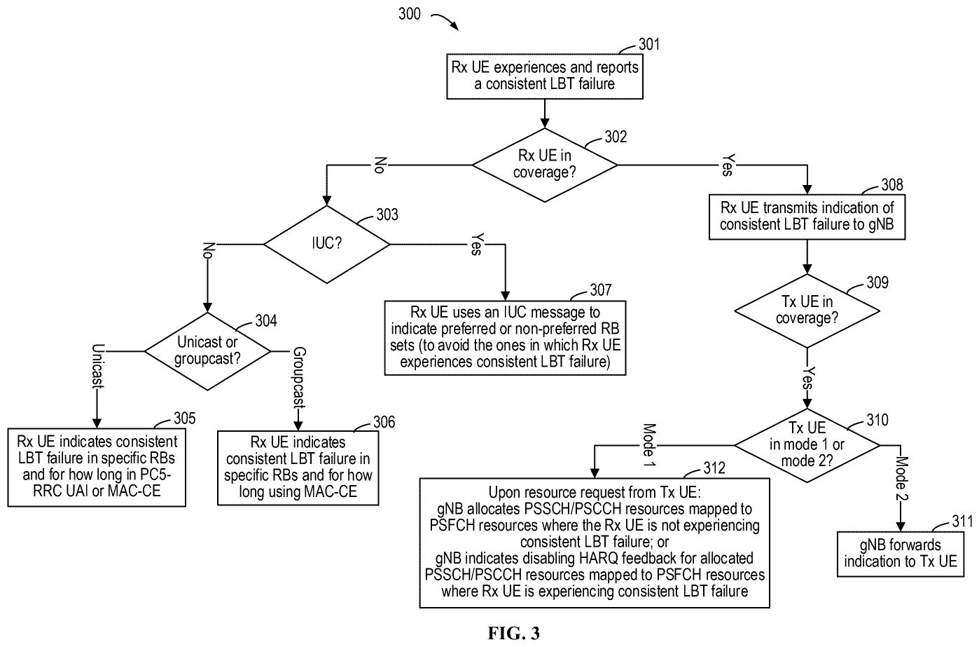

FIG. 3 illustrates a flowchart illustrating a procedure 300 in different cases for the behaviors of first terminal device 120-1 in accordance with some example embodiment of the present disclosure. For the purpose of discussion, the embodiments of FIG. 3 will be described with reference to FIG. 1A.

As an example implementation, in the procedure 300, at 301, the Rx UE 120-1 may experience and report a consistent LBT failure. For example, upon experiencing a consistent LBT failure, the Rx UE 120-1 may indicate to its peers that it is experiencing a consistent LBT failure. At 302, it may be determined whether the Rx UE 120-1 is in coverage of the gNB 110. If the Rx UE 120-1 is out of coverage of the gNB 110 (NO at 302), the procedure 300 may proceed to block 303 and the Rx UE 120-1 may indicate to the Tx UE 120-2 that it is experiencing a consistent LBT failure. At 303, it may be determined whether there is an IUC between the Rx UE 120-1 and the Tx-UE 120-2. If there is not an IUC between the Rx UE 120-1 and the Tx-UE 120-2 (NO at 303), the procedure 300 may proceed to block 304. At 304, it may be determined whether a unicast link or a broadcast link is established between the Rx UE 120-1 and the Tx-UE 120-2.

In some example embodiments, if a unicast link is established between the Rx UE 120-1 and the Tx-UE 120-2, the procedure 300 may proceed to block 305. At 305, the Rx UE 120-1 may indicate the consistent LBT failure occurring in specific RBs and for how long in PC5-RRC UAI or MAC-CE. In other words, when the Rx UE 120-1 is in a non-NW controlled setting (i.e. out-of-coverage and using mode 2) and without inter-UE coordination, for unicast, the Rx UE 120-1 may indicate to the Tx UE 120-2 by means of a PC5-RRC UAI message or a MAC CE that it is experiencing a consistent LBT failure in specific RB sets (and resource pool) and for how long (or estimation of how long). The MAC CE may be transmitted, for example, outside the affected RB sets which might occur in a different resource pool. In the case that the LBT consistent failure is declared at the resource pool level, the working assumption may be that the restriction that the MAC CE has to be sent on the same resource pool is relaxed in the context of the SL-U MAC specifications. In other words, this MAC CE would need to include information about which resource pool the information in the MAC CE is relevant to.

In some example embodiments, if a groupcast link is established between the Rx UE 120-1 and the Tx-UE 120-2, the procedure 300 may proceed to block 306. At 306, the Rx UE 120-1 may indicate the consistent LBT failure occurring in specific RBs and for how long using a MAC-CE. In other words, when the Rx UE 120-1 is in a non-NW controlled setting (i.e. out-of-coverage and using mode 2) and without inter-UE coordination, for groupcast, the Rx UE 120-1 may indicate to the Tx UE 120-2 by means of a MAC CE that it is experiencing a consistent LBT failure in specific RB sets (and resource pool) and for how long (or estimation of how long). The MAC CE may be transmitted, for example, outside the affected RB sets which might occur in a different resource pool. Similar to the unicast case, in the case that the LBT consistent failure is declared at the resource pool level, the restriction that the MAC CE has to be sent on the same resource pool may be relaxed in the context of the SL-U MAC specifications. In other words, this MAC CE would need to include information about which resource pool the information in the MAC CE is relevant to.

In some example embodiments, if there is an IUC between the Rx UE 120-1 and the Tx-UE 120-2 (YES at 303), the procedure 300 may proceed to block 307. At 307, the Rx UE 120-1 may use an IUC message to indicate preferred or non-preferred RB sets so as to avoid the ones in which the Rx UE 120-1 experiences a consistent LBT failure. In other words, when the Rx UE 120-1 is in a non-NW controlled setting with IUC (i.e. out-of-coverage and using mode 2 and with inter-UE coordination), when the Rx UE 120-1 takes the role of UE-A in the IUC framework, the Rx UE 120-1 may indicate all the RB sets where it is currently experiencing consistent LBT failure as non-preferred resources. Alternatively, the Rx UE 120-1 may indicate all RB sets where it is not currently experiencing consistent LBT failure as preferred resources.

In some example embodiments, the IUC messaging exchange may occur over resources where the consistent LBT failure has not been declared. The IUC message may also indicate the RB set as the non-preferred PSCCH/PSSCH resources, which are those resources associated PSFCH that would be in RB sets with consistent LBT failure.

In some example embodiments, in the case that LBT consistent failure is declared at the resource pool level, the assumption is that the IUC framework is extended such that it can be sent in other resource pool other than the one for which the non-preferred resources are relevant to. In other words, the IUC messaging relevant to resource pool A may be sent using the resources in the resource pool B. The implication of this extension would be that IUC messaging would need to include the resource pool ID for which its payload is relevant to.

In some example embodiments, if the Rx UE 120-1 is in coverage of the gNB 110 (YES at 302), the procedure 300 may proceed to block 308. At 308, the Rx UE 120-1 may transmit an indication of the consistent LBT failure to the gNB 110 (e.g. via an RRC message or a MAC-CE in PUSCH). At 309, it may be determined whether the Tx-UE 120-2 is in coverage of the gNB 110. If the Tx-UE 120-2 is in coverage of the gNB 110 (YES at 309), at 310, it may be determined whether the Tx-UE 120-2 is in mode 1 or in mode 2. If the Tx-UE 120-2 is in mode 2, the gNB 110 may forward the indication received from the Rx UE 120-1 to the Tx-UE 120-2.

In other words, when the Tx UE 120-2 is in a non-NW controlled setting in which both the Rx UE 120-1 and the Tx-UE 120-2 are in-coverage but the Tx-UE 120-2 use mode 2, the Rx UE 120-1 may, upon experiencing a consecutive LBT failure, transmit the indication of consistent LBT failure to the gNB 110 (e.g. via an RRC message or MAC-CE in PUSCH), and then the gNB 110 may forward the indication to the Tx UE 120-2.

Alternatively or additionally, when the Rx UE 120-1 is in NW coverage, the Rx UE 120-1 may directly transmit the indication to the Tx UE 120-2. In some example embodiments, any of the implementations where the Rx UE 120-1 is out of coverage in a non-NW controlled setting may apply to the embodiment where the Rx UE 120-1 is in coverage. This is especially effective for cases where only the Rx UE 120-1 is in NW coverage, while the Tx UE is out of NW coverage (i.e., NO at 309).

In some example embodiments, if the Tx-UE 120-2 is in mode 1, at 312, upon resource request from the Tx UE 120-2, the gNB 110 may allocate PSSCH/PSCCH resources mapped to PSFCH resources where the Rx UE 120-1 is not experiencing a consistent LBT failure. Alternatively, the gNB 110 may indicate disabling HARQ feedback for allocated PSSCH/PSCCH resources mapped to PSFCH resources where the Rx UE 120-1 is experiencing a consistent LBT failure.

In other words, when the Tx-UE 120-2 is in a NW controlled setting (i.e. in NW coverage and using mode 1), for unicast and groupcast, upon the Tx UE 120-2 requesting resources to transmit to the Rx UE 120-1, the gNB 110 (if it has received the indication of consistent LBT failure from the Rx UE 120-1) may allocates resources which are mapped to PSFCH locations where the Rx UE 120-1 is not experiencing consistent LBT failure. Alternatively, the gNB 110 may disable HARQ feedback for transmissions allocated in resources mapped to PSFCH locations affected by consistent LBT failure.

In some embodiment, the Rx UE 120-1 may transmit the indication of experienced consistent LBT failure to the gNB 110 over the Uu interface (e.g. via an RRC message or MAC-CE in PUSCH). Alternatively or additionally, the Rx UE 120-1 may transmit the indication of experienced consistent LBT failure to the Tx-UE 120-2 over SL resources (i.e. over a RB set or resource pool) where no consistent LBT failure is experienced.

From the perspective view of the Tx UE 120-2, upon obtaining information about consistent LBT failure occurring in the RX UE 120-1, the Tx UE 120-2 may transmit sidelink transmissions to the Rx UE 120-1 based on the obtained information.

In some example embodiments, when the Tx UE 120-2 is in a non-NW controlled mode (i.e., mode 2) or when the Rx UE 120-1 is out of NW coverage, the Tx UE 120-2 may determine which PSCCH/PSSCH resources are mapped to PSFCH located in RB sets (or resource pools) affected by the consistent LBT failure. In some example embodiments, the Tx UE 120-2 may exclude the determined PSCCH/PSSCH resource from resource selection procedure. In other words, the Tx UE 120-2 may not use these determined PSCCH/PSSCH resources for transmission, otherwise it would not be possible to determine whether Rx UE 120-1 has received the transmission or not.

In some example embodiments, the Tx UE 120-2 may disable HARQ feedback in case the Tx UE 120-2 makes use of the determined PSCCH/PSSCH resources. In addition, the Tx UE 120-2 may also increase the robustness of the transmission, e.g., by reducing the MCS or enabling repetitions for transmitting towards the Rx UE 120-1, so as to increase the probability of reception.

In some example embodiments, when the Tx UE 120-2 is in a NW controlled mode (i.e., mode 1), the Tx UE 120-2 may follows the resource allocation provided by the gNB 110. For example, the Tx UE 120-2 may utilize the resources allocated by the gNB 110, which are mapped to PSFCH locations where the Rx UE 110 is not experiencing consistent LBT failure, for sidelink transmission to the Rx UE 110. Since the Rx UE 110 is not experiencing consistent LBT failure on the mapped PSFCH locations, the Rx UE 110 may provide HARQ feedback to the Tx UE 120-2 and the Tx UE 120-2 may be aware whether HARQ retransmissions are needed. Alternatively, based on the indication received from the gNB 110, the Tx UE 120-2 may disable HARQ feedback for transmissions allocated in resources mapped to PSFCH locations affected by consistent LBT failure and may increase the robustness of the transmission, e.g., by reducing the MCS or enabling repetitions for transmitting towards that RX UE, to increase the probability of reception.

In other words, the Tx UE 120-2 may be able to cope with lack of HARQ feedback, by taking into account if the Rx UE 120-1 is experiencing consistent LBT failure or not in the targeted RB sets (or resource pool). In this way, the reliability of sidelink communication may be improved even in consistent LBT failure situations.

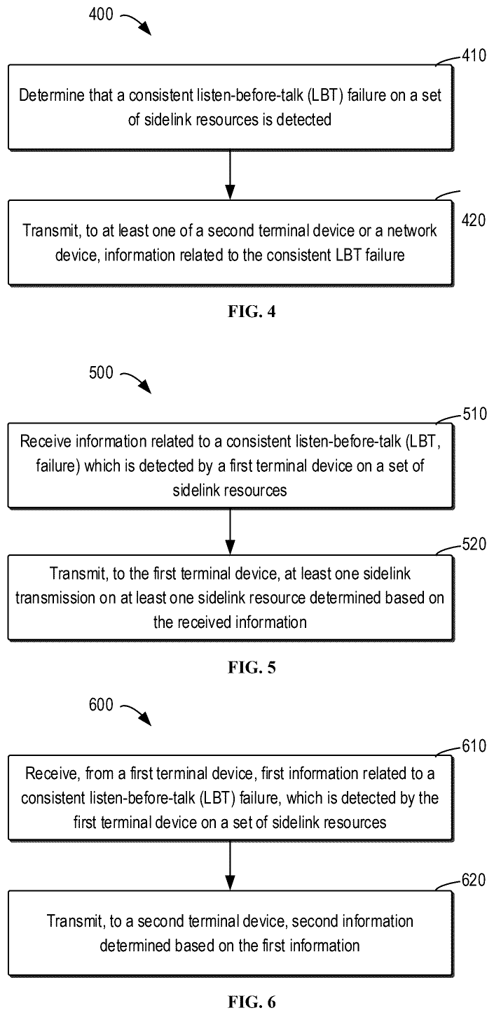

FIG. 4 illustrates a flowchart of an example method 400 implemented at afirst terminal device in accordance with some example embodiments of the present disclosure. For the purpose of discussion, the method 400 will be described from the perspective of the first terminal device 120 with reference to FIG. 1A.

At block 410, the first terminal device 120-1 determines that a consistent LBT failure on a set of sidelink resources is detected. At block 420, the first terminal device 120-1 transmits, to a network device 110, information related to the consistent LBT failure. Alternatively or additionally, the first terminal device 120-1 transmits, to a second terminal device 120-2, information related to the consistent LBT failure.

In some example embodiments, when transmitting the information to the second terminal device 120-2, the first terminal device 120-1 may transmit the information to the second terminal device 120-2 based on determining that the first terminal device 120-1 is out of coverage of the network device 110. In some example embodiments, the first terminal device 120-1 may transmit an IUC message comprising the information based on determining that there is an IUC between the first terminal device 120-1 and the second terminal device 120-2. In some example embodiments, the information may comprise an indication of non-preferred resources including the set of sidelink resources. Alternatively or additionally, the information may comprise an indication of preferred resources excluding the set of sidelink resources.

In some example embodiments, based on determining that there is not an IUC between the first terminal device 120-1 and the second terminal device 120-2, the first terminal device 120-1 may transmit PC5-RRC UAI comprising the information. Alternatively or additionally, based on determining that there is not an IUC between the first terminal device 120-1 and the second terminal device 120-2, the first terminal device 120-1 may transmit a MAC CE comprising the information.

In some example embodiments, based on determining that a unicast link is established between the first terminal device 120-1 and the second terminal device 120-2, the first terminal device 120-1 may transmit the PC5-RRC UAI. Alternatively or additionally, based on determining that a unicast link is established between the first terminal device 120-1 and the second terminal device 120-2, the first terminal device 120-1 may transmit the MAC CE. In some example embodiments, based on determining that a grouplink is established between the first terminal device 120-1 and the second terminal device 120-2, the first terminal device 120-1 may transmit the MAC CE.

In some example embodiments, the set of sidelink resources may be a first resource pool. The information may be transmitted to the second terminal device 120-2 in a second resource pool different from the first resource pool, and the information may comprise an indication of the first resource pool.

In some example embodiments, the first terminal device 120-1 may transmit the information to the network device 110 based on determining thatthe firstterminal device 120-1 is in coverage of the network device 110.

In some example embodiments, the information may comprise an indication that the consistent LBT failure is detected on the set of sidelink resources. Alternatively or additionally, the information may comprise an indication of a duration of the consistent LBT failure. Alternatively or additionally, the information may comprise an indication of the set of sidelink resources.

In some example embodiments, the first terminal device 120-1 may further receive, from the second terminal device 120-2, at least one sidelink transmission on at least one sidelink resource determined based on the information.

In some example embodiments, the at least one sidelink resource may be mapped to at least one PSFCH resource different from the set of sidelink resources. The first terminal device 120-1 may further transmit a HARQ feedback to the second terminal device 120-2 for the at least one sidelink transmission.

In some example embodiments, the at least one sidelink resource may be mapped to at least one PSFCH resource in the set of sidelink resources. The first terminal device 120-1 may further receive, from the second terminal device 120-2, an indication of disabling a HARQ feedback from the first terminal device 120-1 to the second terminal device 120-2 for the at least one sidelink transmission.

In some example embodiments, the set of sidelink resources may comprise at least one resource block (RB) set. Alternatively or additionally, the set of sidelink resources may comprise at least one resource pool. Alternatively or additionally, the set of sidelink resources may comprise at least one bandwidth part.

FIG. 5 illustrates another flowchart of an example method 500 implemented at a network device in accordance with some example embodiments of the present disclosure. For the purpose of discussion, the method 500 will be described from the perspective of the second terminal device 120-2 with reference to FIG. 1A.

At block 510, the second terminal device 120-2 receives information related to a consistent LBT failure, which is detected by a first terminal device 120-1 on a set of sidelink resources. At block 520, the second terminal device 120-2 transmit, to the first terminal device 120-1, at least one sidelink transmission on at least one sidelink resource determined based on the received information.

In some example embodiments, the information may comprise an indication that the consistent LBT failure is detected on the set of sidelink resources. Alternatively or additionally, the information may comprise an indication of a duration of the consistent LBT failure. Alternatively or additionally, the information may comprise an indication of the set of sidelink resources. Alternatively or additionally, the information may comprise an indication of non-preferred resources including the set of sidelink resources. Alternatively or additionally, the information may comprise an indication of preferred resources excluding the set of sidelink resources.

In some example embodiments, the information may be received from the first terminal device 120-1. Alternatively or additionally, the information may be received from the network device 110. In some example embodiments, the information may be received from the network device 110 in the event that the first terminal device 120-1 and the second terminal device 120-2 are in coverage of the network device 110. In some example embodiments, the information may be received from the first terminal device 120-1 in the event that at least one of the first terminal device 120-1 and the second terminal device 120-2 is out of coverage of the network device 110.

In some example embodiments, the information may be received from the first terminal device 120-1 via PC5-RRC UAI. Alternatively or additionally, the information may be received from the first terminal device 120-1 via a MAC CE. Alternatively or additionally, the information may be received from the first terminal device 120-1 via an IUC message.

In some example embodiments, the information may comprise an indication of the at least one sidelink resource, and the information is received from a network device 110. In some example embodiments, based on determining that the second terminal device 120-2 is in a first resource allocation mode, the second terminal device 120-2 may transmit, to the network device 110, a request for allocating resources of the at least one sidelink transmission prior to receiving the information from the network device 110.

In some example embodiments, the at least one sidelink resource may be mapped to at least one PSFCH resource different from the set of sidelink resources. The second terminal device 120-2 may further transmit, to the first terminal device 120-1, an indication of enabling a HARQ feedback from the first terminal device 120-1 to the second terminal device 120-2 for the at least one sidelink transmission.

In some example embodiments, the at least one sidelink resource may be mapped to at least one PSFCH resource in the set of sidelink resources. The second terminal device 120-2 may further transmit, to the first terminal device 120-1, an indication of disabling a HARQ feedback from the first terminal device 120-1 to the second terminal device 120-2 for the at least one sidelink transmission.

In some example embodiments, the second terminal device 120-2 may be caused to transmit the at least one sidelink transmission by reducing a modulation and coding scheme, MCS, of the at least one sidelink transmission. Alternatively or additionally, the second terminal device 120-2 may be caused to transmit the at least one sidelink transmission by enabling repetitions of the at least one sidelink transmission.

In some example embodiments, the set of sidelink resources may comprise at least one resource block (RB) set. Alternatively or additionally, the set of sidelink resources may comprise at least one resource pool. Alternatively or additionally, the set of sidelink resources may comprise at least one bandwidth part.

In some example embodiments, the set of sidelink resources may be a first resource pool. The information may be received from the first terminal device 120-1 in a second resource pool different from the first resource pool, and the information may comprise an indication of the first resource pool.

FIG. 6 illustrates another flowchart of an example method 600 implemented at a network device in accordance with some example embodiments of the present disclosure. For the purpose of discussion, the method 600 will be described from the perspective of the network device 110 with reference to FIG. 1A.

At block 610, the network device 110 receives, from a first terminal device 120-1, first information related to a consistent LBT failure, which is detected by the first terminal device 120-1 on a set of sidelink resources. At block 620, the network device 110 transmits, to a second terminal device 120-2, second information determined based on the first information.

In some example embodiments, the information may comprise an indication that the consistent LBT failure is detected on the set of sidelink resources. Alternatively or additionally, the information may comprise an indication of a duration of the consistent LBT failure. Alternatively or additionally, the information may comprise an indication of the set of sidelink resources.

In some example embodiments, the set of sidelink resources may comprise at least one resource block (RB) set. Alternatively or additionally, the set of sidelink resources may comprise at least one resource pool. Alternatively or additionally, the set of sidelink resources may comprise at least one bandwidth part. In some example embodiments, the first information may be received from the first terminal device 120-1 in the event that the first terminal device 120-1 is in coverage of the network device 110.

In some example embodiments, when transmitting the second information to the second terminal device 120-2, the network device 110 may transmit the second information to the second terminal device 120-2 based on determining that the second terminal device 120-2 is in coverage of the network device 110.

In some example embodiments, the second information may comprise an indication that the consistent LBT failure is detected on the set of sidelink resources. Alternatively or additionally, the second information may comprise an indication of a duration of the consistent LBT failure. Alternatively or additionally, the second information may comprise an indication of the set of sidelink resources.

In some example embodiments, when transmitting the second information to the second terminal device 120-2, the network device 110 may transmit the second information to the second terminal device 120-2 based on determining that the second terminal device 120-2 is in a second resource allocation mode.

In some example embodiments, the second information may comprise an indication of at least one sidelink resource allocated for at least one sidelink transmission to be transmitted from the second terminal device 120-2 to the first terminal device 120-1. In some example embodiments, based on receiving a request for resources for transmitting the at least one sidelink transmission, the network device 110 may determine the at least one sidelink resource allocated for the at least one sidelink transmission. In some example embodiments, the at least one sidelink resource may be mapped to at least one PSFCH resource different from the set of sidelink resources.

In some example embodiments, the at least one sidelink resource may be mapped to at least one PSFCH resource in the set of sidelink resources and the second information may further comprise an indication of disabling a HARQ feedback from the first terminal device 120-1 to the second terminal device 120-2 for the at least one sidelink transmission. In some example embodiments, the second information may further comprise an indication of a reduced MCS of the at least one sidelink transmission. Alternatively or additionally, the second information may further comprise an indication of repetitions of the at least one sidelink transmission.

In some example embodiments, an apparatus capable of performing the method 400 (for example, the first terminal device 120) may comprise means for performing the respective steps of the method 400. The means may be implemented in any suitable form. For example, the means may be implemented in a circuitry or software module.

In some example embodiments, the apparatus comprises: means for determining that a consistent listen-before-talk (LBT) failure on a set of sidelink resources is detected; and means for transmitting, to at least one of a second terminal device or a network device, information related to the consistent LBT failure.

In some example embodiments, the means for transmitting the information to the second terminal device may comprise means for transmitting the information to the second terminal device based on determining that the first terminal device is out of coverage of the network device. In some example embodiments, the apparatus may further comprise means for transmitting an IUC message comprising the information based on determining that there is an IUC between the first terminal device and the second terminal device.

In some example embodiments, the information may comprise an indication of non-preferred resources including the set of sidelink resources. Alternatively or additionally, the information may comprise an indication of preferred resources excluding the set of sidelink resources.

In some example embodiments, the apparatus may further comprise means for transmitting at least one of PC5-RRC UAI or a MAC CE, wherein the at least one of the PC5-RRC UAI or the MAC CE comprises the information. In some example embodiments, the apparatus may further comprise means for transmitting at least one of the PC5-RRC UAI or the MAC CE based on determining that a unicast link is established between the first terminal device and the second terminal device. In some example embodiments, the apparatus may further comprise means for transmitting the MAC CE based on determining that a groupcast link is established between the first terminal device and the second terminal device.

In some example embodiments, the set of sidelink resources may be a first resource pool. The means for transmitting the information may comprise means for transmitting the information to the second terminal device in a second resource pool different from the first resource pool, and the information may comprise an indication of the first resource pool.

In some example embodiments, the means for transmitting the information to the network device may comprise means for transmitting the information to the network device based on determining that the first terminal device is in coverage of the network device.

In some example embodiments, the information may comprise an indication that the consistent LBT failure is detected on the set of sidelink resources. Alternatively or additionally, the information may comprise an indication of a duration of the consistent LBT failure. Alternatively or additionally, the information may comprise an indication of the set of sidelink resources.

In some example embodiments, the apparatus may further comprise means for receiving, from the second terminal device, at least one sidelink transmission on at least one sidelink resource determined based on the information. In some example embodiments, the at least one sidelink resource may be mapped to at least one PSFCH resource different from the set of sidelink resources. The apparatus may further comprise means for transmitting a HARQ feedback to the second terminal device for the at least one sidelink transmission.

In some example embodiments, the at least one sidelink resource may be mapped to at least one PSFCH resource in the set of sidelink resources. The apparatus may further comprise means for receiving, from the second terminal device, an indication of disabling a HARQ feedback from the first terminal device to the second terminal device for the at least one sidelink transmission.

In some example embodiments, the set of sidelink resources may comprise at least one resource block (RB) set. Alternatively or additionally, the set of sidelink resources may comprise at least one resource pool. Alternatively or additionally, the set of sidelink resources may comprise at least one bandwidth part.

In some example embodiments, the apparatus further comprises means for performing other steps in some example embodiments of the method 400. In some example embodiments, the means comprises at least one processor and at least one memory including computer program code. The at least one memory and the computer program code are configured to, with the at least one processor, cause the performance of the apparatus.

In some example embodiments, an apparatus capable of performing the method 500 (for example, the second terminal device 120-2) may comprise means for performing the respective steps of the method 500. The means may be implemented in any suitable form. For example, the means may be implemented in a circuitry or software module.

In some example embodiments, the apparatus comprises: means for receiving information related to a consistent listen-before-talk (LBT) failure, which is detected by a first terminal device on a set of sidelink resources; and means for transmitting, to the first terminal device, at least one sidelink transmission on at least one sidelink resource determined based on the received information.

In some example embodiments, the information may comprise an indication that the consistent LBT failure is detected on the set of sidelink resources. Alternatively or additionally, the information may comprise an indication of a duration of the consistent LBT failure. Alternatively or additionally, the information may comprise an indication of the set of sidelink resources. Alternatively or additionally, the information may comprise an indication of non-preferred resources including the set of sidelink resources. Alternatively or additionally, the information may comprise an indication of preferred resources excluding the set of sidelink resources.

In some example embodiments, the means for receiving information may comprise means for receiving the information from at least one of the first terminal device or a network device. In some example embodiments, the means for receiving the information from the network device may comprise means for receiving the information from the network device in the event that the first terminal device and the second terminal device are in coverage of the network device. In some example embodiments, the means for receiving the information from the first terminal device may comprise means for receiving the information from the first terminal device in the event that at least one of the first terminal device and the second terminal device is out of coverage of the network device.

In some example embodiments, the means for receiving the information from the first terminal device may comprise means for receiving the information from the first terminal device via at least one of PC5-RRC UAI, a MAC CE or an IUC message.

In some example embodiments, the information may comprise an indication of the at least one sidelink resource, and the means for receiving information may comprise means for receiving the information from a network device. In some example embodiments, the apparatus may further comprise means for transmitting, to the network device, a request for allocating resources of the at least one sidelink transmission prior to receiving the information from the network device based on determining that the second terminal device is in a first resource allocation mode.

In some example embodiments, the at least one sidelink resource may be mapped to at least one PSFCH resource different from the set of sidelink resources. The apparatus may further comprise means for transmitting, to the first terminal device, an indication of enabling a HARQ feedback from the first terminal device to the second terminal device for the at least one sidelink transmission.

In some example embodiments, the at least one sidelink resource may be mapped to at least one PSFCH resource in the set of sidelink resources. The apparatus may further comprise means for transmitting, to the first terminal device, an indication of disabling a HARQ feedback from the first terminal device to the second terminal device for the at least one sidelink transmission.

In some example embodiments, the means for transmitting the at least one sidelink transmission may comprise means for transmitting the at least one sidelink transmission by at least one of reducing a modulation and coding scheme, MCS, of the at least one sidelink transmission, or enabling repetitions of the at least one sidelink transmission.

In some example embodiments, the set of sidelink resources may comprise at least one of the following: at least one resource block (RB) set, at least one resource pool or at least one bandwidth part.

In some example embodiments, the set of sidelink resources may be a first resource pool. The means for receiving the information may comprise means for receiving the information from the first terminal device in a second resource pool different from the first resource pool, and the information may comprise an indication of the first resource pool.

In some example embodiments, the apparatus further comprises means for performing other steps in some example embodiments of the method 500. In some example embodiments, the means comprises at least one processor and at least one memory including computer program code. The at least one memory and the computer program code are configured to, with the at least one processor, cause the performance of the apparatus.

In some example embodiments, an apparatus capable of performing the method 600 (for example, the network device 110) may comprise means for performing the respective steps of the method 600. The means may be implemented in any suitable form. For example, the means may be implemented in a circuitry or software module.

In some example embodiments, the apparatus comprises: means for receiving, from a first terminal device, first information related to a consistent listen-before-talk (LBT) failure, which is detected by the first terminal device on a set of sidelink resources; and means for transmitting, to a second terminal device, second information determined based on the first information.

In some example embodiments, the information may comprise an indication that the consistent LBT failure is detected on the set of sidelink resources. Alternatively or additionally, the information may comprise an indication of a duration of the consistent LBT failure. Alternatively or additionally, the information may comprise an indication of the set of sidelink resources.

In some example embodiments, the set of sidelink resources may comprise at least one resource block (RB) set. Alternatively or additionally, the set of sidelink resources may comprise at least one resource pool. Alternatively or additionally, the set of sidelink resources may comprise at least one bandwidth part. In some example embodiments, the means for receiving the first information may comprise means for receiving the first information from the first terminal device in the event that the first terminal device is in coverage of the network device.

In some example embodiments, the means for transmitting the second information to the second terminal device may comprise means for transmitting the second information to the second terminal device based on determining that the second terminal device is in coverage of the network device.

In some example embodiments, the second information may comprise an indication that the consistent LBT failure is detected on the set of sidelink resources. Alternatively or additionally, the second information may comprise an indication of a duration of the consistent LBT failure. Alternatively or additionally, the second information may comprise an indication of the set of sidelink resources.

In some example embodiments, the means for transmitting the second information to the second terminal device may comprise means for transmitting the second information to the second terminal device based on determining that the second terminal device is in a second resource allocation mode.

In some example embodiments, the second information may comprise an indication of at least one sidelink resource allocated for at least one sidelink transmission to be transmitted from the second terminal device to the first terminal device. In some example embodiments, the apparatus may further comprise means for determining the at least one sidelink resource allocated for the at least one sidelink transmission based on receiving a request for resources for transmitting the at least one sidelink transmission. In some example embodiments, the at least one sidelink resource may be mapped to at least one PSFCH resource different from the set of sidelink resources.

In some example embodiments, the at least one sidelink resource may be mapped to at least one PSFCH resource in the set of sidelink resources and the second information may further comprise an indication of disabling a HARQ feedback from the first terminal device to the second terminal device for the at least one sidelink transmission. In some example embodiments, the second information may further comprise an indication of a reduced MCS of the at least one sidelink transmission. Alternatively or additionally, the second information may further comprise an indication of repetitions of the at least one sidelink transmission.

In some example embodiments, the apparatus further comprises means for performing other steps in some example embodiments of the method 600. In some example embodiments, the means comprises at least one processor and at least one memory including computer program code. The at least one memory and the computer program code are configured to, with the at least one processor, cause the performance of the apparatus.

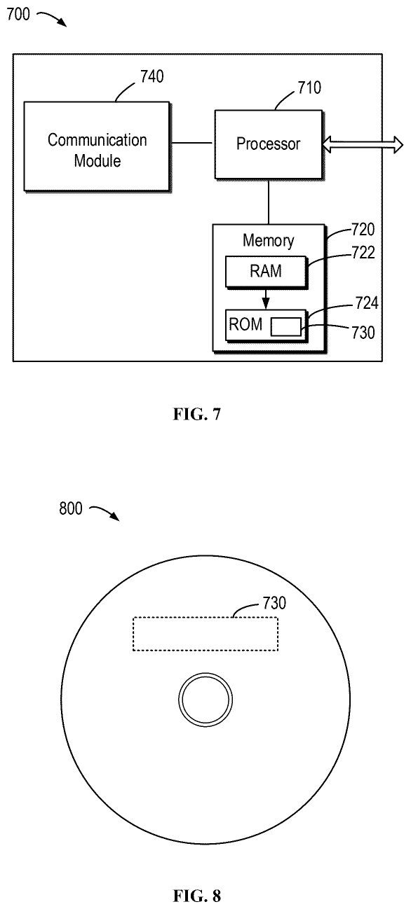

FIG. 7 illustrates a simplified block diagram of a device 700 that is suitable for implementing some example embodiments of the present disclosure. The device 700 may be provided to implement a communication device, for example, the network device 110, the first terminal device 120-1 or the second terminal device 120-2 as shown in FIG. 1A. As shown, the device 700 includes one or more processors 710, one or more memories 720 coupled to the processor 710, and one or more communication modules 740 coupled to the processor 710.

The communication module 740 is for bidirectional communications. The communication module 740 has at least one antenna to facilitate communication. The communication interface may represent any interface that is necessary for communication with other network elements.

The processor 710 may be of any type suitable to the local technical network and may include one or more of the following: general purpose computers, special purpose computers, microprocessors, digital signal processors (DSPs) and processors based on multicore processor architecture, as non-limiting examples. The device 700 may have multiple processors, such as an application specific integrated circuit chip that is slaved in time to a clock which synchronizes the main processor.

The memory 720 may include one or more non-volatile memories and one or more volatile memories. Examples of the non-volatile memories include, but are not limited to, a Read Only Memory (ROM) 724, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 722 and other volatile memories that will not last in the power-down duration.

A computer program 730 includes computer executable instructions that are executed by the associated processor 710. The program 730 may be stored in the ROM 724. The processor 710 may perform any suitable actions and processing by loading the program 730 into the RAM 722.

The embodiments of the present disclosure may be implemented by means of the program 730 so that the device 700 may perform any process of the disclosure as discussed with reference to FIG. 2. The embodiments of the present disclosure may also be implemented by hardware or by a combination of software and hardware.

In some example embodiments, the program 730 may be tangibly contained in a computer-readable medium which may be included in the device 700 (such as in the memory 720) or other storage devices that are accessible by the device 700. The device 700 may load the program 730 from the computer-readable medium to the RAM 722 for execution. The computer-readable medium may include any types of tangible non-volatile storage, such as ROM, EPROM, a flash memory, a hard disk, CD, DVD, and the like.

FIG. 8 illustrates a block diagram of an example of a computer-readable medium 1000 in accordance with some example embodiments of the present disclosure. The computer-readable medium 800 has the program 730 stored thereon. It is noted that although the computer-readable medium 800 is depicted in form of CD or DVD in FIG. 8, the computer-readable medium 800 may be in any other form suitable for carry or hold the program 730.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer-readable storage medium. The computer program product includes computer-executable instructions, such as those included in program modules, being executed in a device on a target real or virtual processor, to carry out the method 400, 500 or 600 as described above with reference to FIG. 4, 5 or 6. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer-readable medium, and the like.

The computer-readable medium may be a computer-readable signal medium or a computer-readable storage medium. A computer-readable medium may include but not limited to an electronic, magnetic, optical, electromagnetic, infrared, or semiconductor system, apparatus, or device, or any suitable combination of the foregoing. More specific examples of the computer-readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. The term “non-transitory,” as used herein, is a limitation of the medium itself (i.e., tangible, not a signal) as opposed to a limitation on data storage persistency (e.g., RAM vs. ROM).

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A first terminal device comprising:
at least one processor; and
at least one memory storing instructions that, when executed by the at least one processor, cause the first terminal device at least to:
determine that a consistent listen-before-talk, LBT, failure on a set of sidelink resources is detected; and
transmit, to at least one of a second terminal device or a network device, information related to the consistent LBT failure.

2. The first terminal device of claim 1, wherein the first terminal device is caused to transmit the information to the second terminal device by:
based on determining that the first terminal device is out of coverage of the network device, transmit the information to the second terminal device.

3. The first terminal device of claim 1, wherein the first terminal device is caused to transmit the information to the network device by:
based on determining that the first terminal device is in coverage of the network device, transmit the information to the network device.

4. The first terminal device of claim 1, wherein the information comprises at least one of the following:
an indication that the consistent LBT failure is detected on the set of sidelink resources;
an indication of a duration of the consistent LBT failure; or
an indication of the set of sidelink resources.

5. The first terminal device of claim 1, wherein the first terminal device is further caused to:
receive, from the second terminal device, at least one sidelink transmission on at least one sidelink resource determined based on the information.

6. The first terminal device of claim 5, wherein the at least one sidelink resource is mapped to at least one physical sidelink feedback channel, PSFCH, resource different from the set of sidelink resources, and the first terminal device is further caused to:
transmit a hybrid automatic repeat request, HARQ, feedback to the second terminal device for the at least one sidelink transmission.

7. The first terminal device of claim 5, wherein the at least one sidelink resource is mapped to at least one PSFCH resource in the set of sidelink resources, and the first terminal device is further caused to:
receive, from the second terminal device, an indication of disabling a HARQ feedback from the first terminal device to the second terminal device for the at least one sidelink transmission.

8. The first terminal device of claim 1, wherein the set of sidelink resources comprise at least one of the following:
at least one resource block, RB, set;
at least one resource pool; or
at least one bandwidth part.

9. A network device comprising:
at least one processor; and
at least one memory storing instructions that, when executed by the at least one processor, cause the network device at least to:
receive, from a first terminal device, first information related to a consistent listen-before-talk, LBT, failure, which is detected by the first terminal device on a set of sidelink resources; and
transmit, to a second terminal device, second information determined based on the first information.

10. The network device of claim 9, wherein the first information comprises at least one of the following:
an indication that the consistent LBT failure is detected on the set of sidelink resources;
an indication of a duration of the consistent LBT failure; or
an indication of the set of sidelink resources.

11. The network device of claim 10, wherein the set of sidelink resources comprise at least one of the following:
at least one resource block, RB, set;
at least one resource pool; or
at least one bandwidth part.

12. The network device of claim 10, wherein the first information is received from the first terminal device in the event that the first terminal device is in coverage of the network device.

13. The network device of claim 10, wherein the network device is caused to transmit the second information to the second terminal device by:
based on determining that the second terminal device is in coverage of the network device, transmit the second information to the second terminal device.

14. The network device of claim 10, wherein the second information comprises at least one of the following:
an indication that the consistent LBT failure is detected on the set of sidelink resources;
an indication of a duration of the consistent LBT failure; or
an indication of the set of sidelink resources.

15. The network device of claim 10, wherein the second information comprises an indication of at least one sidelink resource allocated for at least one sidelink transmission to be transmitted from the second terminal device to the first terminal device.

16. A method comprising:
determining, at a first terminal device, that a consistent listen-before-talk, LBT, failure on a set of sidelink resources is detected; and
transmitting, to at least one of a second terminal device or a network device, information related to the consistent LBT failure.

17. The method of claim 16, wherein the transmitting the information to the second terminal device comprises:
based on determining that the first terminal device is out of coverage of the network device, transmitting the information to the second terminal device.

18. The method of claim 16, wherein the transmitting the information to the network device comprises:
based on determining that the first terminal device is in coverage of the network device, transmit the information to the network device.

19. The method of claim 16, wherein the information comprises at least one of the following:
an indication that the consistent LBT failure is detected on the set of sidelink resources;
an indication of a duration of the consistent LBT failure; or
an indication of the set of sidelink resources.

20. The method of claim 16, wherein the set of sidelink resources comprise at least one of the following:
at least one resource block, RB, set;
at least one resource pool; or
at least one bandwidth part.
